(19) United States
(12) Patent Application Publication
(10) Pub. No.: US 2025/0338859 A1
(43) Pub. Date: Nov. 6, 2025

(54) DEVICE, SYSTEM AND METHOD FOR APPLYING FLOUR ONTO A DOUGH PIECE

(71) Applicant: AMF Tromp B.V., Gorinchem (NL)

(72) Inventors: Mari Lucas Vroegh, Gorinchem (NL); Cornelis Van Der Plaat, Gorinchem (NL)

(73) Assignee: AMF Tromp B.V., Gorinchem, OT (NL)

(21) Appl. No.: 18/870,219

(22) PCT Filed: Jun. 1, 2023
(86) PCT No.: PCT/NL2023/050306

§ 371 Date: Nov. 27, 2024

(30) Foreign Application Priority Data
Jun. 1, 2022 (NL) 2032042

(51) Int. Cl. A21C 9/04

(52) U.S. Cl. CPC A21C 9/04

(57) ABSTRACT

The invention relates to a device, system and method for applying flour onto a dough piece. The device according to the invention comprises a reservoir for providing a supply of flour, an agitator for displacing at least part of the flour in the reservoir and a flour applicator configured to apply flour to a dough piece, wherein the device is configured such that flour is applied onto a dough piece by means of the flour applicator upon contact therewith.

The invention relates to a device for applying flour onto a dough piece. The invention also relates to a system for applying flour onto a dough piece. The invention additionally relates to a method for applying flour onto a dough piece

In conventional automated bakery process, the dough products are to be covered with flour in order to prevent the dough from sticking onto the machinery components. Conventional dough flour applicators make for example use of gravity and/or an air flow and thus typically drizzle flour over the dough pieces. It is also conceivable that the dough pieces are placed or dropped upon a layer of flour. A drawback of these techniques is that it is rather inefficient in terms of spillage of flour and that the degree of control of the application of flour is not very accurate. However, for the application of flour to the upper and/or bottom side of a dough piece, there techniques are sufficient. However, a further challenge pops up when the sides of the dough product are to be provided with flour. The state of the art is not sufficiently accurate to apply flour in a controlled manner to the substantially vertical sides of a dough pieces.

An alternative for the application of flour is for example the application of oil in stead of flour. Oil can be applied in a more controlled manner, for example by means of a roller or a bush. However, the oil could affect the product as such and an additional drawback is that if oil is applied, the oil is be included in the list of ingredients. One can imagine that this is undesired.

Hence, it is a goal of the invention to provide an improved solution for the application of flour onto a dough piece, in particular in a controlled manner. It is a further a goal of the invention to at least provide an alternative to the existing solutions for applying flour onto a dough piece.

The invention provides thereto a device for applying flour onto a dough piece, said device comprising at least one reservoir in particular for providing a supply of flour, at least one agitator in particular configured for displacing at least part of the flour in the reservoir, at least one flour applicator, in particular a movable or displaceable flour applicator, configured to apply flour to a dough piece, wherein the reservoir comprises at least one feed through opening, and wherein the agitator is configured for displacing flour from said reservoir through the at least one feed through opening and/or for displacing flour from said reservoir onto the flour applicator, such that at least part of the flour applicator will be covered with flour and wherein during movement of the flour applicator the flour is carried by the flour applicator and such that flour can be applied onto a dough piece upon contact.

The device according to the present invention has several benefits over conventional devices for applying flour onto a dough piece. The movable flour applicator according to the present invention enables a continuous and controlled transport of flour and/or a continuous and controlled application of flour onto a dough piece. At least one agitator enables displacement of flour in the reservoir such that agglomeration is prevented and/or such that flour is flour is displaced from the reservoir onto the flour applicator preferably via displacement through the at least one feed through opening. The device according to the invention enables that at least part of the flour applicator will be covered with flour during use. When part of the flour applicator is covered with flour, it can be said that a layer of flour is formed on the surface of the flour applicator. This enables both relatively easy transport and relatively easy release of the flour. Basically, flour can be transported or carried via the surface of the flour applicator during movement thereof. Due to the flour applicator being at least partially covered with flour, said flour can be applied onto a dough piece when it comes into contact with the flour layer. Flour will be released from the flour applicator upon contact with the dough piece. Since the flour can be applied in a controlled manner, relatively small amounts of flour can be used and the flour can be location at predetermined positions of the dough piece. It is for example conceivable that substantially vertical sides of a dough piece are provided with flour. This is typically difficult to arrange with conventional system, but is nevertheless of severe importance as it are in particular the sides of a dough piece which may stick or adhere to a further part of the processing line. It is a further benefit that there is no need to make use of an air flow or a scattered way of providing flour when applying the device according to the present invention. This is beneficial as flour can be applied in a more controlled manner resulting in less spillage, a tidier device and environment and thus less fouling of the device and/or of the entire system wherein the device is used. Further, the movable flour applicator according to the present invention can ensure that flour is applied upon the most relevant parts of the food product, i.e. the parts which will contact the flour applicator are typically the same parts as which would get into contact with, and thus possibly stick to, further machinery parts in the processing line.

The flour applicator is in particular a direct contact applicator or a direct contact flour applicator. The flour applicator is in particular configured for direct contact between flour and a dough piece. The flour applicator can for example also be referred to as a (flour) transport structure. At least one agitator is for example a mixing element. At least one agitator is preferably configured for direct or indirect displacement of flour. At least one agitator can for example be configured for providing an oscillating, a rotating and/or a knocking pattern. At least one agitator may in particular be configured to push flour onto the flour applicator. It is imaginable that at least one agitator is a spiral agitator. In a further possible embodiment, at least one agitator can comprise at least one spring, preferably at least one helical spring. The use of at least one spring, in particular a helical spring, can be beneficial to ensure continuous supply of flour to the feed through opening. In a possible embodiment, it is conceivable that at least part of at least one agitator is driven via at least one gear, preferably a toothed gear. In case at least one (helical) spring is applied, it is imaginable that said (helical) spring is driven via at least one (toothed) gear. It is also conceivable that the device comprises multiple agitators. It is conceivable that at least two different agitators is applied and/or a combination of the described agitators.

At least one reservoir can be any type of reservoir which is configured and/or suitable for containing flour. At least one reservoir can for example be a hopper. It is beneficial if at least part of the reservoir is substantially rounded. In this way, clogging of flour in the corners of the reservoir be minimized or even prevented. At least one reservoir could for example comprise at least one inlet and/or at least one outlet. It is imaginable that at least one outlet of the reservoir is defined by at least one feed through opening. It is also conceivable that the device comprises multiple reservoirs. The feed though opening is preferably shaped such that it allows controlled displacement of flour wherein it is prevented that flour will be falling out of the hopper. The feed through opening does not necessarily need to form integral part of the reservoir. It is also conceivable that the reservoir defines at least part of the feed through opening or that the reservoir form a boundary of the feed through opening. The reservoir may also adjoin the feed through opening. The functional of the feed through opening is to provide an access from the reservoir towards the flour applicator, in particular such that the flour applicator can bring along or carry flour from the reservoir to a location where it can be applied onto a dough piece. At least one movable flour applicator is in particular movable with respect to the reservoir.

The device according to the present invention is in particular configured for use in bakery processes. However, when it is referred to flour any other equivalent or similar food products, preferably powdery food products, can be meant too. Non-limiting examples of flour which could be applied within the device of the present invention are wheat flour, cereal flour, bread flour, cake flour, pastry flour, self-rising flour, instant flour, 00-flour, semolina flour, rye flour, spelt flour, gluten-free flour, almond flour, buckwheat flour, chickpea flour, corn flour, oat flour, potato flour and/or rice flour. When it is referred to a dough piece in particular a is a dough product or a food product can be meant. When it is referred to a dough piece, also a dough sheet can be meant. The shape of the dough piece is not of particular relevance for the invention. Hence, the term dough piece is non-limiting may be interchanged with the term food product. The dough piece could for example be an endless dough piece or (endless) dough sheet. In particular, the invention related to the application of a powdery food additive to a food product in a controlled manner.

The flour applicator may comprise at least one surface or surface area which is configured to be at least partially covered with flour. Preferably, the displacement of flour from the reservoir onto the flour applicator is conducted such that at least part of a surface of the flour applicator will be covered with flour and in particular wherein during movement of the flour applicator the flour is carried by the flour applicator and such that flour can be applied onto a dough piece upon contact between the dough piece and the flour layer present upon the surface of the flour applicator. The direct contact between the dough piece and the flour will cause that the flour will stick onto the dough piece.

In order to further control the flour processing, at least part of the flour applicator preferably comprises a structured surface or a profiled surface. A structured surface or profiled surface can further enhance controlled retaining and/or transport of flour. The structure applied can for example be configured for retaining flour. Since flour can agglomerate and/or fall down when it is provided in a (substantially) vertical layer, the use of a structured surface may prevent this. It is for example conceivable that the structure comprises grooves and/or received spaces. A groove and/or receiving space could form a boundary for flour and/or a groove and/or receiving space could receive a predetermined amount of flour. It is also conceivable that at least part of the structured surface comprises an elongated and/or vertically oriented configuration. Once could also imagine that at least part of the structured surface comprises a relief and/or a texture. It is also conceivable that at least part of the structured surface of the flour applicator comprises a repeated pattered. This could further contribute to controlled handling of the flour. It is for example conceivable that the structure comprises a waffle, groove and/or v-shape pattern. Preferably at least part of an outer surface of the flour applicator comprises a structured surface. The structure surface may be formed by a substantially 3-D configuration. The structured surface is preferably substantially rigid.

It is beneficial if at least part of surface of the flour applicator is oriented in a different direction than its transport direction. Hence, it is conceivable that at least part of the surface of the flour applicator which is configured to be covered with flour is oriented substantially vertically. The flour applicator is preferably configured for movement in a substantially horizontal plane. It is beneficial if at least part of the surface of the flour applicator, and preferably of the structure if applied, which is to be covered with flour extends in a direction different from the direction of movement of the flour applicator. Hence, if the direction of movement of the flour applicator is in the x-direction, it is beneficial if the surface of the flour applicator which is to be covered also extends in the y-direction and/or z-direction. Typically, a predetermined area of the surface of the flour applicator is configured to be covered with flour. It is also conceivable that the flour applicator comprises multiple surfaces, wherein at least one and possibly each surface comprises a structure.

In a beneficial embodiment, at least one flour applicator comprises an endless belt. The use of an endless belt can further optimize the continuous character of the flour applicator and may positively contribute to continuous and controlled transport and/or release of flour. It is imaginable that at least part of the endless belt, such as a surface thereof, is configured to be covered with flour. It is also conceivable that at least one flour applicator comprises a transport conveyor. It is conceivable that at least part of the endless belt comprises a structured surface in particular as described for the present invention. The endless belt can ensure that, during operation, the supply of flour is continuously refreshed. An endless belt can further contribute to controlling the location of the flour release and/or to guidance of the dough piece within the process. It is conceivable that the endless belt comprises at least one surface, in particular a structured surface.

It is also imaginable that at least one flour applicator comprises a rotatable drum. It is conceivable that at least part of the movable flour applicator is configured to rotate with respect to the reservoir. A substantially rotatable flour applicator can result in a relatively compact configuration of the device. In case a rotatable drum is applied, it is conceivable that at least part of the rotatable drum comprises a structured surface in particular as described for the present invention. The flour applicator is preferably configured for continuous rotation, preferably in a continuous and stable manner. It is also conceivable that the flour applicator comprises at least one endless belt and at least one rotatable drum. It is conceivable that the rotatable drum is configured to supply flour onto the endless belt, or vice versa. The endless belt and/or the rotatable drum preferably comprise a structured surface or a profiled surface.

Preferably, the device according to the invention comprises at least one drive unit for at least driving the movable flour applicator. It is also conceivable that the device comprises at least one drive unit configured for at least driving at least one agitator. It is also conceivable that multiple drive units are applied. A non-limiting example of a drive unit which can be applied is an electromotor. The device according to the present invention is preferably substantially automated. Alternatively, it is also conceivable that the device is a manually activated and/or manually driven device.

In a preferred embodiment, at least part of at least one agitator is positioned inside the reservoir. In this way, the agitator can control the displacement of flour directly and efficiently. At least one agitator can for example be an internal mixer. At least one agitator is preferably displaceable with respect to the reservoir and/or with respect to the feed through opening of the reservoir. It is also conceivable that the device comprises at least one external mixing element (or agitator). For example, an external mixing element can be configured to provide an oscillating motion of at least part of the reservoir such that displacement of flour occurs. The use of an external mixing element may prevent agglomeration of flour within the reservoir.

The dimensions of at least one feed through opening are preferably adjustable. The dimension could preferably be adjusted based upon the dimensions and/or configuration of the flour applicator and/or based upon the dimensions of the reservoir. At least one feed through opening is in a preferred embodiment substantially elongated, preferably in a substantially vertical orientation. It is for example conceivable that at least one feed through opening is substantially vertically oriented. The length direction of the feed through opening can for example be substantially perpendicular to a processing path over which dough pieces are transported, wherein the processing path is for example defined by a conveyor. It is also possible that at least one feed through opening is substantially vertically oriented, wherein the length direction of the feed through opening extends towards at least one inlet of the reservoir. The inlet of the reservoir is preferably positioned at a distance from the feed though opening. At least the width of at least one feed through opening is preferably adjustable. The height of the feed through opening is preferably adapted based upon the intended use. Hence, in case relatively large dough pieces are to be applied with flour, the height of the feed through opening, and thus the height of the area of the flour applicator which is covered with flour may be sufficiently high to provide said dough piece with flour. It is in particular desired to control the amount of flour which is applied upon the flour applicator. Being able to adjust the width of the feed through opening enables that the amount of flour which is applied onto to the flour applicator can be controlled in a relatively simple manner. A predetermined width could results in a predetermined thickness of the applied flour layer. The width of at least one feed through opening can for example be in the range of 0.05 to 0.3 mm. It is for example conceivable that the width is in the range of 0.05 and 0.15 mm or in the range of 0.15 to 0.3 mm. The feed through opening can for example be a slit. The use of an adjustable width of the feed through opening could also be beneficial in case different types of flour, or equivalent powders, are to be applied within the same device. The feed though opening can for example have a predetermined width. It is for example conceivable that the width of at least one feed through opening is substantially equal over its length. In this way, a substantially equally divided coverage of flour upon the flour applicator can be created. In a beneficial embodiment, at least one feed through opening comprises at least one dosing element. The dosing element can for example be configured to control the dosing of flour upon the flour applicator and/or for controlling the amount of flour supplied upon the flour applicator. The dosing element could in particular be configured to limit the supply of flour upon the flour applicator. The dosing element can for example be a scraper. The use of a dosing element enables control of the dimension and performance of the feed through opening in a relatively simple manner. As indicated above, it is beneficial if the thickness of the layer of flour upon the flour applicator can be controlled as this will contribute to the efficiency and accuracy of the device. The use of predetermined amount and/or thickness of flour can prevent an excess of flour. A too thick layer of flour upon the (surface of the) flour applicator could result in flour falling down, for example when the flour applicator is moving. Obviously, this could negatively affect the overall process and may even hinder the actual application of flour onto a dough product. The presence of a too thin layer should also be avoided as this could still result in the dough product sticking to the flour applicator.

In a possible embodiment it is imaginable that at least part of at least one flour applicator is positioned within the reservoir. In this way, the supply of flour onto the flour applicator can be further controlled. It is for example conceivable that at least part of the flour applicator, and in particular of a surface of the flour applicator, is covered with flour when said part is located inside the reservoir. Hence, the reservoir and the flour applicator are preferably positioned such that flour can be directly transferred from the reservoir onto the flour applicator.

It is for example conceivable that least part of the flour applicator is enclosed by the reservoir and wherein preferably at least (another) part of the flour applicator is positioned outside the reservoir. Hence, it is conceivable that part of the flour applicator is positioned inside the reservoir whereas part of the flour applicator is positioned outside the reservoir or at a distance from the reservoir.

In a beneficial embodiment, the device, and in particular the reservoir comprises at least one secondary feed through opening for receiving (left over) flour from the flour applicator back into the reservoir. The secondary feed through opening could for example be referred to as an entrance opening. Flour which is not consumed during the transport can then be provided back to the reservoir. The initial, primary feed though opening can for example be referred to as a dosing opening. An embodiment comprising at least one secondary feed through opening is in particular of interest in case the flour applicator comprises an endless belt or in case the flour applicator comprises a rotatable drum. This embodiment is also of interest in case part of the flour applicator is positioned inside the reservoir and wherein at least part of the flour applicator is positioned outside the reservoir.

It is beneficial if the device, and in particular the reservoir, comprises at least one level sensor. Such level sensor can for example be configured for indicating the flour level inside the reservoir. The use of a level sensor can positively contribute to further automatization and/or optimization of the device and/or process. The level of the level sensor may for example be a trigger for the provided supply of flour. The device may optionally comprise a supply channel for supplying flour. It is also conceivable that the device according to the invention is configured for cooperation with an external supply channel. It is conceivable that the supply of flour is adjusted based upon the indicated amount of flour present in the reservoir. It is also imaginable that the device is configured to stop movement of the flour applicator in case the level of flour is considered below a threshold value. It is also conceivable that the device comprises at least one further sensor, such as but not limited to a temperature sensor, a humidity sensor, a flow sensor and/or a pressure sensor. The device may comprise a control unit for regulating the agitator, flour applicator and if applied the at least one sensor and/or drive unit.

The invention also relates to a system for applying flour to a dough piece, in particular a dough piece moving along a processing path, said system comprising at least one device according to the present invention and at least one conveyor, wherein the conveyer is configured to transport dough pieces along a processing path which is preferably substantially parallel to the flour applicator of the device such that flour can be applied onto a dough piece upon contact. The system is preferably a continuous system or a system configured for use in a continuous process of applying flour to a dough piece. The system according to the invention has similar benefits as the device according to the invention, whereas the system additionally benefits of further automatization due to the use of a conveyor for the supply of dough pieces which are to be applied with flour. Preferably, at least part of the conveyor and at least part of the flour applicator are configured to move in the same direction. Alternatively, the flour applicator and the conveyor could be configured to move in opposite directions.

The invention further relates to a method of applying flour to a dough piece, in particular using a system according to the present invention, said method comprising the steps of:
providing a supply of flour;
covering at least part of at least one movable flour applicator with flour;
providing at least one dough piece along a processing path which is substantially parallel to the flour applicator such that flour can be applied onto a dough piece upon contact.

The invention also relates to a flour applicator for applying flour to a dough piece according to the present invention.

The invention will be further elucidated by means of non-limiting exemplary embodiments illustrated in the following figures, in which:

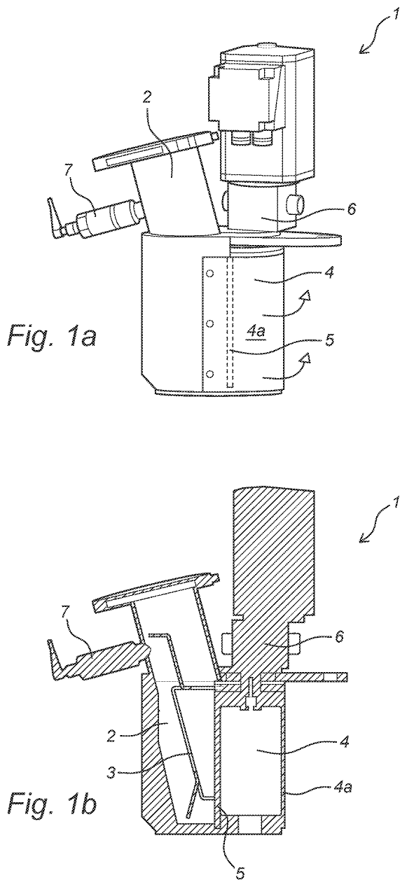

FIGS. 1a and 1b show a first possible embodiment of a device according to the present invention;

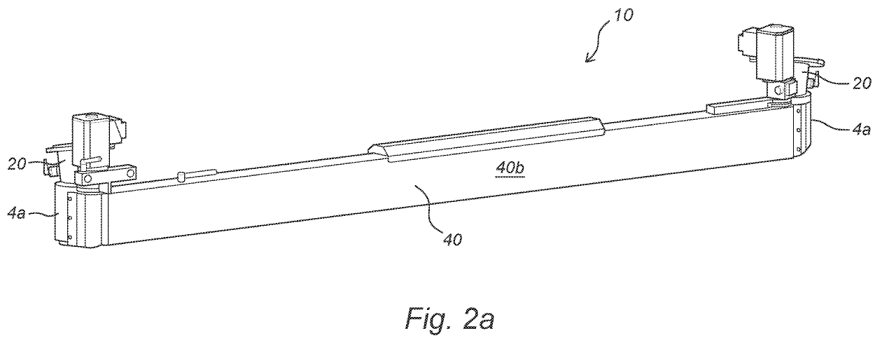

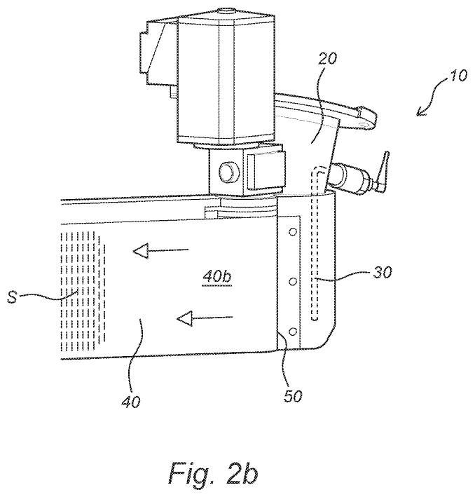

FIGS. 2a and 2b show a second possible embodiment of a device according to the present invention; and

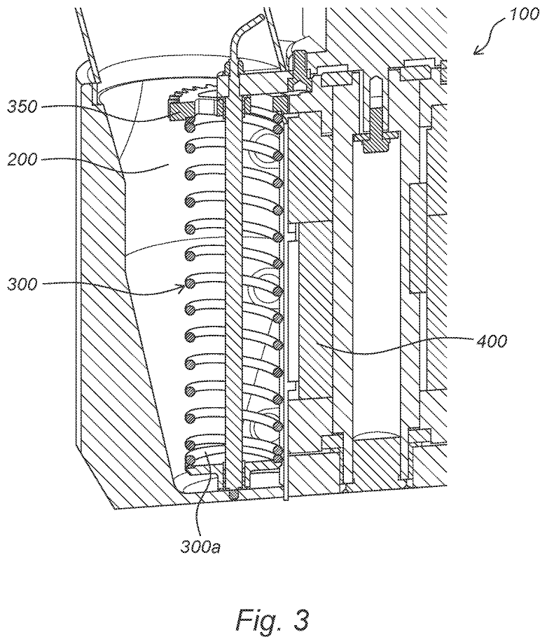

FIG. 3 shows a detailed view of a possible embodiment of a device according to the present invention.

Within these figures, similar reference numbers correspond to similar or equivalent elements or features.

FIGS. 1a and 1b show a schematic representation of a first possible embodiment of a device 1 for applying flour to dough piece (not shown) with flour (not shown). FIG. 1a shows a perspective view whereas FIG. 1b shows a partially open, cross sectional view. The device 1 comprises a reservoir 2 for providing a supply of flour, an agitator 3 for displacing at least part of the flour in the reservoir 2 and a movable flour applicator 4 configured to apply flour to a dough piece. In the shown embodiment, at least part the agitator 3 is positioned inside the reservoir 2. The reservoir 2 comprises at least one feed through opening, indicatively identified with reference number 5, for throughput of flour from the reservoir to the flour applicator 4. The agitator 3 is configured for displacing flour within the reservoir 2 thereby preventing agglomeration and/or for enabling displacement of flour through the feed through opening 5 and/or onto the flour applicator 4. The co-action between the agitator 2, the feed through opening 5 and the flour applicator 4 is configured to ensure that flour provided by the reservoir is put onto the flour applicator 4 such that at least part of the flour applicator 4 is covered with flour. The flour applicator 4 of the shown embodiment comprises a rotatable drum 4a. The arrows indicate the direction of rotation of the drum 4a. The rotatable drum 4a is configured to rotate with respect to the reservoir 3. The device 1 further comprises a drive unit 6, in particular an electromotor 6, for driving at least the movable flour applicator 4. The reservoir 2 is provided with a level sensor 7. The reservoir 2 further a secondary feed through opening (not shown) for receiving flour from the flour applicator 4 back into the reservoir 2, which opening is positioned at an opposite side of the reservoir 2 with respect to the (primary) feed through opening 5.

FIGS. 2a and 2b show a second possible embodiment of a device 10 according to the present invention. FIG. 2a shows a perspective view, whereas FIG. 2b shows a detailed view. The device 10 comprises a reservoirs 20, agitators 30 and a flour applicator 40. The reservoir 20 comprises a feed through opening for throughput of flour from the reservoir 20 to the flour applicator 40. Part of the flour applicator 40 is positioned within the reservoir 20 and part of the flour applicator 40 is positioned outside the reservoir 20. The flour applicator 40 comprises a rotatable drum 4a and an endless belt 40b. It is schematically indicated that part of the flour applicator 40 comprises a structured surface S. This embodiment is in particular suitable for applying flour onto an endless dough piece or endless dough sheet.

FIG. 3 shows a further possible embodiment of a device 100 according to the present invention. The figure show in particular a detailed, cross sectional view of a possible embodiment of an agitator 300. The figure shows the agitator 300 which is received within the reservoir 200. The further embodiment of the device 100 corresponds with the device as shown in FIGS. 1a and 1b. The agitator 300 is configured for displacing at least part of the flour in the reservoir 200 towards the movable flour applicator 400 which is configured to apply flour to a dough piece. The shown embodiment shows a spiral agitator 300. The agitator 300 more in particular comprises a helical spring 300a. The helical spring 300a can ensure continuous supply of flour to the feed through opening. In the shown embodiment, the agitator 300 is driven via a toothed gear 350.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A device for applying flour onto a dough piece, said device comprising:
at least one reservoir for providing a supply of flour which reservoir comprises at least one feed through opening;
at least one agitator for displacing at least part of the flour in the reservoir; and
at least one movable flour applicator configured to apply flour to a dough piece, wherein at least part of the flour applicator comprises a structured surface;
wherein part of the flour applicator is positioned inside the reservoir and part of the flour applicator is positioned outside the reservoir, and wherein the agitator is configured for displacing flour from said reservoir onto the flour applicator, such that at least part of the flour applicator will be covered with flour; and
wherein during movement of the flour applicator the flour is carried by the flour applicator and such that flour can be applied onto a dough piece upon contact.

2. The device according to claim 1, wherein at least one feed through opening is elongated in a vertical orientation.

3. The device according to claim 1, wherein the structured surface comprises a repeated pattern.

4. The device according to claim 1, wherein at least one flour applicator comprises an endless belt.

5. The device according to claim 1, wherein at least one flour applicator comprises a rotatable drum.

6. The device according to claim 1, comprising at least one drive unit for driving at least the movable flour applicator.

7. The device according to claim 1, wherein at least part of at least one agitator is positioned inside the reservoir.

8. The device according to claim 1, wherein the dimensions of at least one feed through opening are adjustable.

9. The device according to claim 1, wherein feed through opening comprises at least one dosing element preferably configured for controlling the amount of flour supplied upon the flour applicator.

10. The device according to claim 1, wherein at least part of the surface of the flour applicator extends in a direction different from the direction of movement of the flour applicator.

11. The device according to claim 1, wherein the structure comprises grooves and/or receiving spaces.

12. The device according to claim 1, wherein the reservoir comprises at least-one secondary feed through opening for receiving flour from the flour applicator back into the reservoir.

13. The device according to claim 1, wherein the reservoir comprises at least one level sensor for indicating the flour level inside the reservoir.

14. A system for applying flour to a dough piece moving along a processing path, said system comprising at least one device according to claim 1 and at least one conveyor, wherein the conveyer is configured to transport dough pieces along a processing path which is parallel to the flour applicator of the device such that flour can be applied onto a dough piece upon contact.

15. The system according to claim 14, wherein at least part of the conveyor and at least part of the flour applicator are move in the same direction.

16. A method of applying flour to a dough piece using a system according to claim 14, said method comprising the steps of:
providing a supply of flour;
covering at least part of at least one movable flour applicator with flour; and
providing at least one dough piece along a processing path which is parallel to the flour applicator such that flour can be applied onto a dough piece upon contact.
